(19) United States
(12) Patent Application Publication
(10) Pub. No.: US 2026/0110995 A1
(43) Pub. Date: Apr. 23, 2026

(54) DISTRIBUTED ENERGY DATA PLATFORM PROCESS

(71) Applicant: MISOINFO Tech., Seoul (KR)

(72) Inventors: Dong-wook An, Seoul (KR); Sang-do NAM, Seoul (KR); Jin-ho SON, Hanam-si (KR); Dong Woo KIM, Incheon (KR); Deun Gil Son JUNG, Ansan-si (KR); Jong-jin PARK, Incheon (KR)

(21) Appl. No.: 18/963,443

(22) Filed: Nov. 27, 2024

(30) Foreign Application Priority Data
Oct. 21, 2024 (KR) 10-2024-0144203

(51) Int. Cl. G05B 19/042; G06N 20/00

(52) U.S. Cl. CPC G05B 19/042; G06N 20/00; G05B 2219/2639

(57) ABSTRACT

One aspect of the present disclosure relates to a distributed energy data platform process, and more particularly, to a distributed energy data platform process capable of increasing efficiency of energy resources and ensuring flexibility in management by configuring an AIoT process based on a distributed energy data platform. The distributed energy data platform process includes a data collection unit for collecting IoT sensor data of an IoT sensor installed in an energy-consuming device in real time; a database for loading the IoT sensor data collected in real time from the data collection unit; a visualization unit for interacting with the database so as to visualize the IoT sensor data to monitor the IoT sensor data in real time; and a training unit for configuring an artificial intelligence life cycle operation for the IoT sensor data.

### STATEMENT OF GOVERNMENT SUPPORT

This work was supported by the Ministry of Trade, Industry & Energy. (Project Unique Number: 2410000171; Project Number: 00400278; Implementing Ministry Name: Ministry of Trade, Industry and Energy; Research Management Specialist Institution(Institution concluding business agreement with managing institution): Korea Institute of Energy Technology Evaluation and Planning; Research Business Name: Development and demonstration of AI-based integrated platform for safety management of distributed and standby power; Research Project Name: Development and demonstration of AI-based integrated platform for safety management of distributed and idle resources; Managing Institution: Gridwiz Co., Ltd.; and Research Period: Apr. 1, 2019-Dec. 31, 2027)

### BACKGROUND OF THE INVENTION

### 1. Field of the Invention

One aspect of the present disclosure relates to a distributed energy data platform process, and more particularly, to a distributed energy data platform process capable of increasing efficiency of energy resources and ensuring flexibility in management by configuring an AIoT process based on a distributed energy data platform.

### 2. Description of the Related Art

Recently, as global warming and depletion of fossil fuels become social problems, energy conservation has become an issue. Accordingly, various technologies capable of saving energy are being developed in each technical field. For example, devices for preventing speeding and inducing an economic speed are being developed in automobiles, and technologies for reducing standby power are also being developed in home appliances.

Although various contents for practicing energy conservation in homes and buildings are being discussed, most of these are social movements, energy conservation policies, and the like that are implemented manually by will of people. For example, an unplugging campaign, an indoor temperature 1-degree raising campaign, and the like are representative examples. However, these have problems that effects are small when people who are subjects of such actions do not actively participate, and results thereof vary greatly depending on trends.

In this situation, technologies related to an energy management system (EMS) are being proposed. The energy management system may monitor power usage of management target devices, and control the management target devices so that the management target may efficiently use power.

As an IT technology and a smart grid technology develop, the energy management system technology is being advanced into an energy efficiency technology for an entire industry, such as energy storage system (ESS) control, building energy management (building-EMS), and factory energy management (factory-EMS), as well as distributed resource monitoring.

In particular, for maintenance and management of new renewable energy, a supervisory control and data acquisition (SCADA) system has been applied so as to be utilized for remote management and control of distributed resources such as solar power generation, wind power generation, and fuel cell power generation. However, since an existing SCADA technology was configured to perform monitoring and sequence control within a limited communication network, there were limitations in remote integrated control, and since a control system involving control of field management personnel was utilized, an operating cost of business was high.

Accordingly, distributed energy resource management systems and methods for collecting or receiving distributed energy resource data in real time based on an Internet-of-Things (IoT) communication module, analyzing the distributed energy resource data to produce prediction information, and performing remote control have been developed.

However, conventional technologies lacked an IoT process based on a distributed energy data platform, so that there were limitations in performing real-time monitoring, remote control, and retraining on the collected data, which resulted in reduced efficiency of energy resources and reduced flexibility in management.

### DOCUMENTS OF RELATED ART

### Patent Documents

(Patent Document 0001) Korean Patent Registration No. 10-2063383 (published on Feb. 11, 2020) “Integrated management system and method for distributed resources”
(Patent Document 0002) Korean Patent Registration No. 10-2682881 (published on Jul. 9, 2024) “IoT-based distributed energy management method”

### SUMMARY OF THE INVENTION

To solve the problems described above, an object of one aspect of the present disclosure is to provide a distributed energy data platform process capable of increasing efficiency of energy resources and ensuring flexibility in management by performing real-time monitoring and remote control on data collected through an IoT sensor, and applying machine learning operations (MLOps) to real-time data so as to perform fault prediction and artificial intelligence life cycle operation configuration.

To achieve the object described above, according to one aspect of the present disclosure, there is provided a distributed energy data platform process including: a data collection unit for collecting IoT sensor data of an IoT sensor installed in an energy-consuming device in real time; a database for loading the IoT sensor data collected in real time from the data collection unit; a visualization unit for interacting with the database so as to visualize the IoT sensor data to monitor the IoT sensor data in real time; a training unit for configuring an artificial intelligence life cycle operation for the IoT sensor data; a server for transmitting the IoT sensor data collected in real time from the data collection unit; and a client for receiving the IoT sensor data transmitted from the server.

In addition, the data collection unit may include: a collection module for streaming-collecting the IoT sensor data in real time; a verification module for verifying the IoT sensor data in real time; a preprocessing module for streaming-preprocessing the IoT sensor data in real time; and a prediction module for streaming-artificial-intelligence-predicting the IoT sensor data in real time.

In addition, the database may be loaded with at least one data among type-specific real-time streaming data, analysis data, artificial intelligence prediction data, and log data of the IoT sensor data.

In addition, the visualization unit may include: an SQL module for configuring a dataset of the IoT sensor data based on a query; a widget module for configuring a widget based on the dataset of the IoT sensor data; a dashboard module for configuring a dashboard based on the dataset and the widget of the IoT sensor data; a management module for managing the dashboard of the IoT sensor data; and a rendering module for rendering the IoT sensor data and a state of the energy-consuming device.

In addition, the training unit may apply machine learning operations (MLOps) to real-time data, and the artificial intelligence life cycle operation of the training unit may include at least one of data inspection and exploration, preprocessing and feature analysis, algorithm selection, model evaluation, and model serving for the IoT sensor data.

In addition, the distributed energy data platform process may further include: an IoT sensor control unit for controlling sensor equipment based on anomaly detection for the IoT sensor installed in the energy-consuming device, an artificial intelligence prediction result, and a user manual.

In addition, the distributed energy data platform process may further include: an object storage connected to the database so as to perform history backup of the IoT sensor data, training dataset configuration, and column-oriented database backup.

According to an embodiment of the present disclosure, a distributed energy data platform process may configure an IoT sensor for the distributed energy data platform, a real-time streaming monitoring dashboard, an IoT remote control service, and an artificial intelligence machine learning operations (MLOps) service, so that efficiency of available energy resources can be increased, and optimization and flexibility in energy resource management can be ensured.

### BRIEF DESCRIPTION OF THE DRAWINGS

FIG. 1 is a schematic view showing a configuration of a distributed energy data platform process according to one aspect of the present disclosure.

FIG. 2 is a view showing a configuration of the distributed energy data platform process according to one aspect of the present disclosure.

FIG. 3 is a flowchart of the distributed energy data platform process according to one aspect of the present disclosure.

FIG. 4 is a flowchart shown diagrammatically by using images to help understand the flowchart of FIG. 3.

### DETAILED DESCRIPTION OF THE INVENTION

Various embodiments and/or aspects will be disclosed with reference to the drawings. In the following description, for the purpose of description, numerous specific details are set forth in order to assist an overall understanding of one or more aspects. However, it will also be appreciated by a person having ordinary skill in the art to which the present disclosure pertains that such aspect(s) may be practiced without the specific details. The following description and the accompanying drawings will be set forth in detail for specific illustrative aspects among the one or more aspects. However, the aspects are provided for illustrative purposes, some of various schemes based on principles of various aspects may be employed, and descriptions set forth herein are intended to encompass all the aspects and equivalents thereof. In detail, the terms “embodiment”, “example”, “aspect”, “illustration”, and the like used herein may not be construed as indicating that any aspect or design set forth herein is preferable or advantageous over other aspects or designs.

Hereinafter, the same reference numerals will be given for the same or similar components regardless of the reference numerals, and redundant descriptions thereof will be omitted. In addition, in the following description of an embodiment disclosed herein, detailed descriptions of relevant known technologies will be omitted when they may obscure the gist of the embodiment disclosed herein. In addition, the accompanying drawings are intended only to facilitate understanding of the embodiment disclosed herein, and the technical idea disclosed herein is not limited by the accompanying drawings.

Although the terms such as “first” and “second” are used to describe various elements or components, the elements or components are not limited by the terms. The terms are used only to distinguish one element or component from another element or component. Therefore, a first element or component that will be set forth below may be a second element or component within the technical idea of one aspect of the present disclosure.

Unless defined otherwise, all terms (including technical and scientific terms) used herein may have the same meanings as how they are commonly understood by a person having ordinary skill in the art to which the present disclosure pertains. In addition, any terms that are defined in general dictionaries are not to be interpreted to have idealistic or excessively meanings unless explicitly and specifically defined.

Further, the term “or” is intended to signify an inclusive “or” rather than an exclusive “or”. In other words, unless specified otherwise or contextually clear, the expression “X uses A or B” is intended to signify one of natural inclusive substitutions. That is, when X uses A; X uses B; or X uses both A and B, the expression “X uses A or B” may be applied to any of the above cases. In addition, it is to be understood that the term “and/or” used herein refers to and includes all possible combinations of one or more of listed relevant items.

In addition, it is to be understood that the terms “include” and/or “comprise” indicate the presence of corresponding features and/or components, but do not preclude the presence or addition of one or more other features, components, and/or groups thereof. Further, unless specified otherwise or contextually clear to indicate a singular form, an expression in a singular form is to be generally construed as including a meaning of “one or more” in the present disclosure and the claims.

In addition, the terms “information” and “data” used herein may often be used interchangeably.

When one component is described as being “connected” or “accessed” to another component, it is to be construed as being connected or accessed to the other component directly, but also as possibly having another component in between. Meanwhile, when one component is described as being “directly connected” or “directly accessed” to another component, it is to be construed that there is no other component in between.

The suffixes “module” and “unit” for components used in the following description are given or used interchangeably only for the convenience of writing the disclosure, so that they do not have distinct meanings or roles in themselves.

Objects and effects of the present disclosure and the technical configurations for achieving the same will be clarified with reference to the following detailed description of embodiments taken in conjunction with the accompanying drawings. In the following description of the present disclosure, detailed descriptions of known functions or configurations will be omitted when they may unnecessarily obscure the gist of the present disclosure. In addition, the terms that will be described below are terms defined in consideration of functions in the present disclosure, so that the terms may vary depending on the intention of a user or operator, precedents, or the like.

However, the present disclosure may be embodied in various different forms without being limited to the embodiments disclosed below. The present embodiments are only provided so that the present disclosure will be thorough and complete, and will fully convey the scope of the disclosure to a person having ordinary skill in the art to which the present disclosure pertains, and the present disclosure will be defined only by the scope of the claims. Therefore, the definition thereof is to be made based on the content throughout the present disclosure.

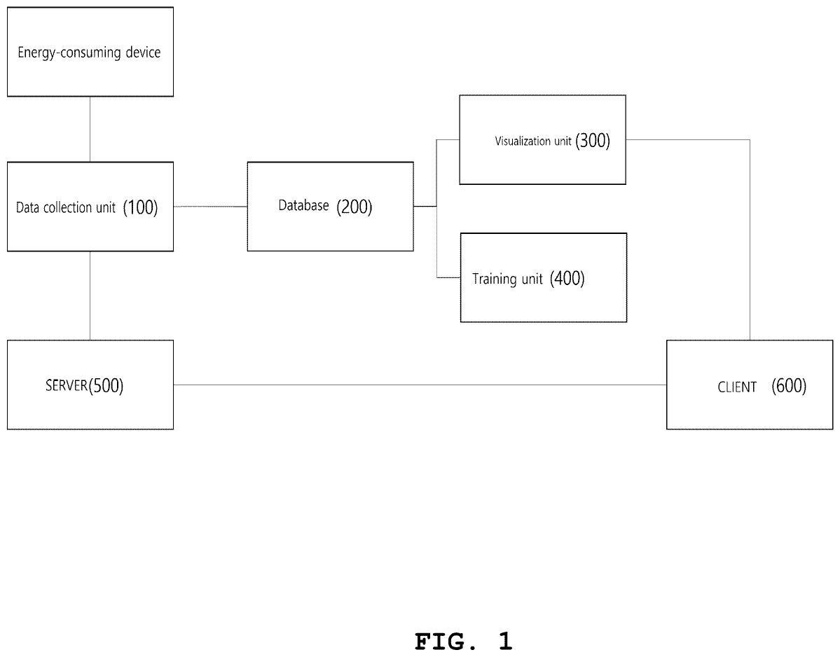

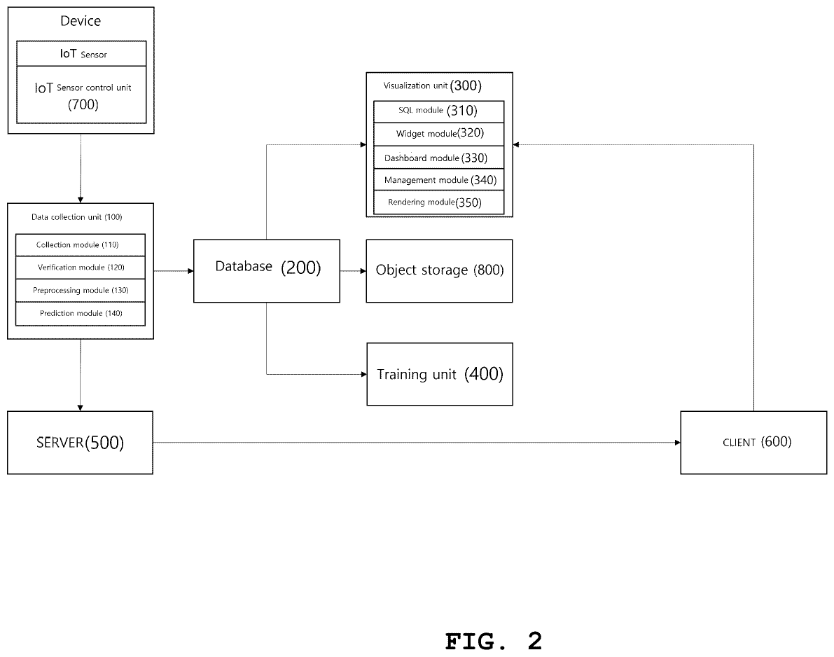

FIG. 1 is a schematic view showing a configuration of a distributed energy data platform process according to one aspect of the present disclosure, and FIG. 2 is a view showing a configuration of the distributed energy data platform process according to one aspect of the present disclosure.

According to one aspect of the present disclosure, a process may collect distributed energy data from an IoT sensor installed in an energy-consuming device, preprocess the data, generate a series of learning models, and provide real-time monitoring.

In other words, according to one aspect of the present disclosure, the process may also be referred to as a system or a main server, and may be implemented as at least one computing device including a processing device for processing information, a storage device, a wired/wireless communication device, and the like. It will be understood by those skilled in the art that the present disclosure may be combined with other programs and/or modules so as to be implemented as a combination of hardware and software.

In detail, according to the present disclosure, the computing device may be installed thereon with a program that may be executed on a central processing unit based on hardware including the central processing unit, a storage device such as a memory and a hard disk, wired communication equipment, and wireless communication equipment such as Bluetooth, that is, software so as to execute the software. A series of specific configurations for the software will be described below as component units such as “modules”, “units”, and “interfaces”.

For example, the computing device may include any type of computer system or computer device, such as a microprocessor, a mainframe computer, a digital processor, a portable device, or a device controller.

A processor may generally process an overall operation of the computing device. The processor may process a signal, data, information, and the like, which are input or output through components included in the computing device, or operate an application program stored in a storage unit, thereby providing or processing appropriate information or functions to a user.

In addition, embodiments described in the present disclosure may also be implemented in a distributed computing environment where some tasks are performed by remote processing devices that are connected to each other through a communication network. In the distributed computing environment, program modules may be located in both local and remote memory storage devices.

The computing device may generally include various computer-readable media. A medium that may be accessed by the computing device may include volatile and nonvolatile media, transitory and non-transitory media, and removable and non-removable media. By way of example and not limitation, the computer-readable medium may include a computer-readable storage medium and a computer-readable transmission medium.

The computer-readable storage medium may include volatile and nonvolatile media, transitory and non-transitory media, and removable and non-removable media, which are implemented in any scheme or technology for storing information such as a computer-readable instruction, a data structure, a program module, or other data. The computer-readable storage medium may include: a RAM, a ROM, an EEPROM, a flash memory, or other memory technologies; a CD-ROM, a digital video disk (DVD), or other optical disk storage devices; a magnetic cassette, a magnetic tape, a magnetic disk storage device, or other magnetic storage devices; or any other medium that may be accessed by a computer and used to store desired information, but is not limited thereto.

The computer-readable transmission medium may generally include any information transmission medium that embodies a computer-readable instruction, a data structure, a program module, or other data in a modulated data signal such as a carrier wave or other transport mechanisms. The term “modulated data signal” may refer to a signal in which at least one of features of the signal is set or changed so as to encode information in the signal. By way of example and not limitation, the computer-readable transmission medium may include a wired medium such as a wired network or direct-wired connection, and a wireless medium such as acoustic, RF, infrared, or other wireless media. Combinations of any of the media described above may also be included in the scope of the computer-readable transmission medium.

In addition, the computing device may operate in a networked environment by using logical connection of a remote computing device(s) and the like to at least one remote computer through wired and/or wireless communication. The remote computing device(s) may be a workstation, a server computer, a router, a personal computer, a portable computer, a microprocessor-based entertainment device, a peer device, or other general network nodes, and may include wired/wireless connection to a local area network (LAN) and/or a larger network, for example, a wide area network (WAN). Such LAN and WAN networking environments are common in offices and companies, and may facilitate an enterprise-wide computer network such as an intranet, all of which may be connected to a worldwide computer network such as the Internet.

Such a computing device may be configured such that a plurality of program modules including at least one application program, other program modules, and program data may be stored in a drive and a RAM. All or portions of operating systems, applications, modules, and/or data may also be cached in the RAM. It will be appreciated that the present disclosure may be implemented in various commercially-available operating systems or combinations of operating systems.

A user may input instructions and information to the computing device through at least one wired/wireless input device, for example, a keyboard and a pointing device such as a mouse. Other input devices may include a microphone, an IR remote control, a joystick, a game pad, a stylus pen, a touch screen, and the like. These and other input devices may often be connected to the processing device through an input device interface connected to a system bus, but may also be connected by other interfaces such as a parallel port, an IEEE 1394 serial port, a game port, a USB port, an IR interface, and the like.

In addition, the user may receive information through a display device including a visual presentation device such as a monitor, and the display device may be connected to the computing device through an interface such as a video adapter, or the display device itself may be the computing device. In this case, it will be naturally understood by those skilled in the art that, in addition to the display device, the computing device and/or the display device may generally include other peripheral output devices such as a speaker and a printer.

Hereinafter, a distributed energy data platform process according to one aspect of the present disclosure will be described in detail with reference to the accompanying drawings.

As shown in FIG. 1, the distributed energy data platform process according to one aspect of the present disclosure may include a data collection unit 100, a database 200, a visualization unit 300, a training unit 400, a server 500, and a client 600.

The data collection unit 100 may collect IoT sensor data of an IoT sensor installed in an energy-consuming device in real time, and the data collection unit 100 may include a collection module 110, a verification module 120, a preprocessing module 130, and a prediction module 140 so as to perform a function thereof.

In this case, the IoT sensor data may be data collected from a sensor mounted in the device, in which the sensor may be equipment for sensing distributed energy for maintenance, management, and control of distributed energy resources, and a type and a form of the sensor may be not be particularly limited, including a case where the sensor is mounted, included, equipped, or installed in the energy-consuming device, or a case where the device itself is a sensor.

The collection module 110 may be a module for collecting various IoT sensor data for monitoring and controlling a distributed energy production device in real time.

The collection module 110 may perform real-time streaming collection from the energy-consuming device based on a reception protocol such as LoRa, Zigbee, Wi-Fi, and 5G, and a data streaming store such as Kafka, MQTT, and CoAP may be used for the streaming.

In addition, the collection module 110 may collect metadata from the IoT sensor data so as to perform device-specific introduction data schema, validity verification, and connection management, and when the collected IoT sensor data is massive to cause a load according to introduction, auto-scaling and self-healing may be performed with a load balancing criterion operation process such as Kubernetes.

The verification module 120 may verify the IoT sensor data collected by the collection module 110 in real time, and may perform data validity verification, quality verification, and schema verification based on the metadata on the IoT sensor data.

In this case, the validity verification of the verification module 120 may be data verification such as a data dictionary definition match check, a value range check, an essential content check, and a duplicate check for the IoT sensor data collected according to various protocols.

The quality verification of the verification module 120 may be data verification such as a data source check, a time synchronization check, a missing detection check, noise filtering, and anomaly value detection for the collected IoT sensor data.

The schema verification of the verification module 120 may be verification of a schema match check based on the metadata for the collected IoT sensor data.

The preprocessing module 130 may serve to streaming-preprocess the IoT sensor data in real time, and may perform loading for raw data analysis and select a feature for artificial intelligence learning model prediction after preprocessing various IoT sensor data.

In detail, the preprocessing module 130 may perform preprocessing such as standardization and normalization of the IoT sensor data, real-time missing value processing, feature creation and extraction, data windowing, data aggregation and summary, data conversion and encoding, and data security.

In addition, the preprocessing module 130 may select a feature based on preprocessing data for the artificial intelligence model prediction and metadata by device type, and may transmit monitoring data standardized based on the metadata according to a web socket scheme for the real-time monitoring of the IoT sensor data.

In addition, the preprocessing module 130 may load a source and the metadata in the database 200 that will be described below based on schema defined in metadata for the preprocessing raw data analysis.

The prediction module 140 may streaming-artificial-intelligence-predict the IoT sensor data in real time, and may perform artificial intelligence learning model prediction by data AI type for various IoT sensor data.

In detail, the prediction module 140 may perform servicing for artificial intelligence prediction based on metadata by IoT sensor data type, loading of the database 200 for result data analysis, and management for the result data analysis.

Furthermore, similar to the collection module 110 described above, the prediction module 140 may also perform auto-scaling and self-healing with a load balancing criterion operation process such as Kubernetes upon model serving and loading.

In other words, the data loaded in the database 200 from the preprocessing module 130 and the prediction module 140 may be one of type-specific real-time streaming data, analysis data, artificial intelligence prediction data, and log data of the IoT sensor data, which will be described below.

The database 200 may be loaded with the IoT sensor data collected, verified, preprocessed, and predicted from the data collection unit 100.

In this case, the database 200 may be loaded with at least one data among type-specific real-time streaming data, analysis data, artificial intelligence prediction data, and log data, and as described above, such data may be data loaded from the preprocessing module and the prediction module.

The real-time streaming data may be data obtained by organizing and storing various IoT sensor data such as a temperature, humidity, a pressure, and a movement collected from the data collection unit 100 in time series, so that an equipment failure, an environmental change, or the like may be rapidly handled, and an anomaly occurrence time may be simply specified.

The analysis data may be data that is subjected to the preprocessing such as standardization and normalization of the IoT sensor data, real-time missing value processing, feature creation and extraction, data windowing, data aggregation and summary, data conversion and encoding, and data security, that is, analysis, from the preprocessing module.

The prediction data may be data that is subjected to the servicing for artificial intelligence prediction based on metadata by IoT sensor data type from the prediction module.

The log data may be data stored for an entire operation history of the process according to one aspect of the present disclosure, and the IoT sensor data that is not included in the real-time streaming data, the analysis data, and the prediction data may be included in the log data.

In this case, the database 200 may perform optimization of compression and storage of the IoT sensor data, data reading and query processing, large-scale data analysis support, data integration and aggregation, sorting and indexing, and security and access control. In order to perform such functions smoothly and rapidly and to interwork with an object storage 800 that will be described below, the database 200 may preferably be a column-oriented database.

Furthermore, the distributed energy data platform process according to one aspect of the present disclosure may further include an object storage 800.

The object storage 800 may be connected to the database 200 so as to perform history backup of the IoT sensor data, training dataset configuration, and column-oriented database backup, and the object storage 800 may be intended to store an object according to purpose by type for various IoT sensor data.

In detail, the object storage 800 may perform the history backup of the IoT sensor data so as to optimize a storage space of the database 200, may optimize the storage space through periodic column-oriented database backup, and may store a large-scale dataset and manage a dataset version for various IoT sensor data.

The object storage 800 may provide an interface for promoting rapid and easy data recovery and use to the client 600 together with an automated configuration for a dataset and backup.

The visualization unit 300 may interact with the database 200 so as to visualize the IoT sensor data to monitor the IoT sensor data in real time, and may include an SQL module 310, a widget module 320, a dashboard module 330, a management module 340, and a rendering module 350 so as to perform the role thereof.

The SQL module 310 may be a module for configuring a dataset of the IoT sensor data loaded in the database 200 based on a query, and an SQL may be a programming language for searching for desired information, that is, performing a query, in the database.

According to one aspect of the present disclosure, the SQL module 310 may optimize the query for efficient searching and processing of the configured dataset, and may perform connection management of each database 200 when the database 200 is divided.

The SQL module 310 may serve to support configuration of real-time monitoring widgets and dashboards based on the IoT sensor data through data visualization by the widget module 320 and the dashboard module 330, which will be described below. In other words, the SQL module may perform conversion and filtering functions for the data visualization.

The widget module 320 may be a module for configuring a widget based on the dataset of the IoT sensor data, and may perform connection setting and data binding functions between the dataset of the IoT sensor data converted and filtered from the SQL module 310 and the widget.

The widget module 320 may filter and provide data according to configurations of various widgets, for example, widgets such as a chart, a grid, a filter, a carousel, and a pivot, in order to promote convenience of a user or a manager, and may also have a data view cycle function so as to update the widgets in real time or change a layout of the widgets.

In addition, since there are various types of widgets, the widget module 320 may also have an appropriate template function such as preview, data binding, and simple chart configuration in order to rapidly configure the widgets.

The dashboard module 330 may be a module for configuring a dashboard based on the dataset and the widget of the IoT sensor data, and may provide various data visualizations for monitoring the IoT sensor data in real time.

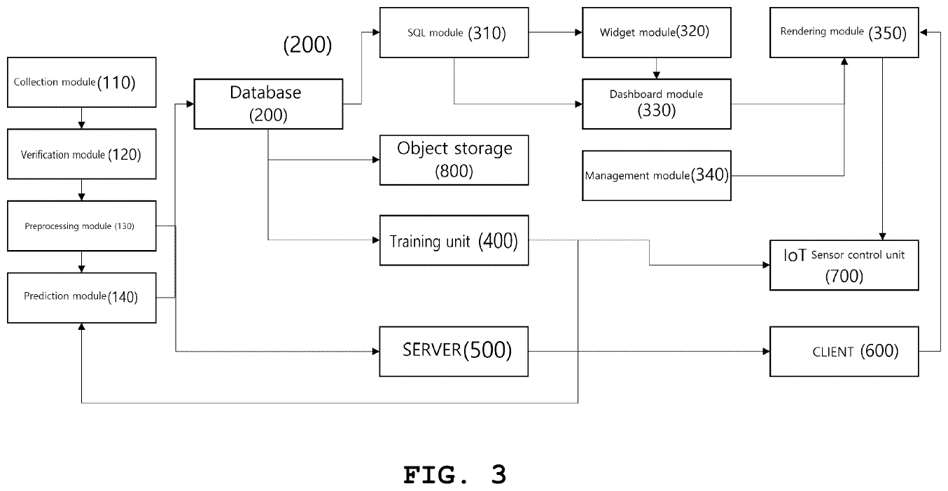

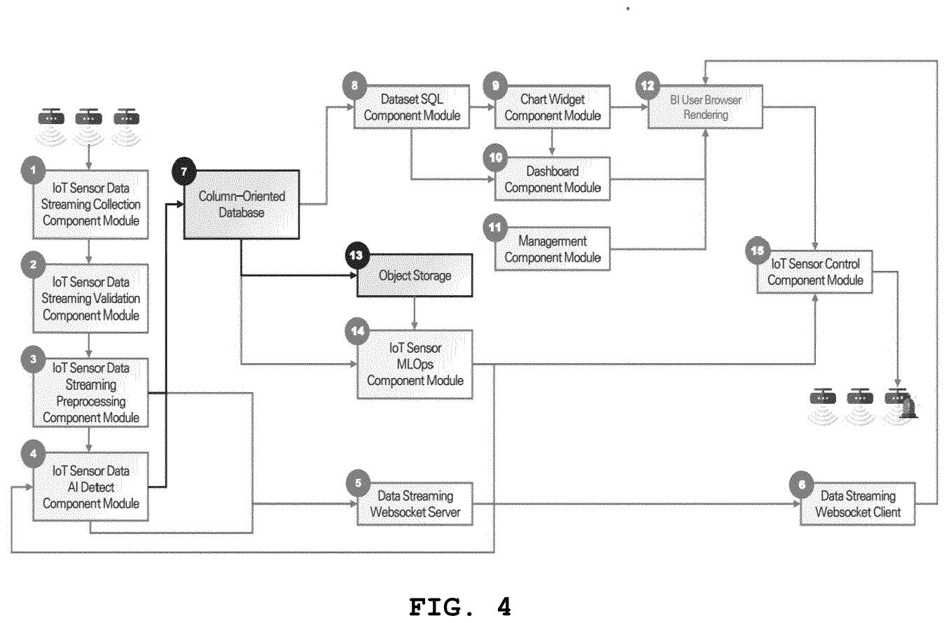

Referring to FIGS. 3 and 4, the dashboard module 330 may receive the dataset from the SQL module 310 or receive the configured widget from the widget module 320 so as to configure the dashboard, so that inefficiency of configuring the dashboard based only on the configured widget may be resolved. In addition, the configured widget may be directly provided from the widget module 320 to the rendering module 350 that will be described below so that the dashboard module 330 may not be necessarily used upon browsing of the widget.

In other words, the dashboard module 330 may serve to configure the dashboard based on the dataset and the widget so as to allow the user to visually monitor the IoT sensor data in real time, so that the dashboard module 330 may have the following functions.

The dashboard module 330 may configure a dashboard-page-specific layout function, a widget setting function, and a data binding function. In this case, a theme and a style of the widget within the dashboard may be set, a state of the widget may be checked, and dataset mapping according to a widget filter may be supported.

In addition, the dashboard module 330 may have a template function and a template-based data binding function, which are for rapidly configuring the dashboard, as well as a search function and a dashboard sharing and distribution function, which are for user convenience, and may manage access authority of the client 600 for dashboard governance.

The management module 340 may be a module for managing the dashboard of the IoT sensor data.

In detail, the management module 340 may be a module for managing the dashboard of the IoT sensor data based on the dataset and the widget, and the management module 340 may configure a dashboard-page-specific layout function, a widget setting function, and a data binding function, and configure a dataset mapping filtering function according to the state, the theme, and the style of the widget within the dashboard, and the widget filter.

In addition, the management module 340 may allow the dashboard to reflect the IoT sensor data, and may share and distribute the dashboard to the user.

The rendering module 350 may serve to render the IoT sensor data to provide the IoT sensor data to a consumer, that is, perform browsing.

In this case, the browsing of the rendering module 350 may be diverse, such as rendering of a distributed energy data platform portal based on a web browser, rendering of the object storage 800 based on a web browser by directly interworking with the object storage 800, rendering of an alarm based on various events and artificial intelligence prediction result threshold values, and rendering of a management function based on Spring Security and an electronic government framework, which may enable customization of a type and an amount of the dataset provided by turning on/off some of the functions or adding a new tab according to the user.

The training unit 400 may configure and train an artificial intelligence life cycle operation for the IoT sensor data.

In this case, the artificial intelligence life cycle operation may refer to an operation such as data inspection and exploration, preprocessing and feature analysis, algorithm selection, model evaluation, and model serving, and the training unit 400 may perform at least one of such artificial intelligence life cycle operations. In this case, a life cycle may refer to all life stages of data, such as creation, recording, processing, and disposal of the data.

In this case, the training unit 400 may apply machine learning operations (MLOps) to real-time data so as to implement training for the artificial intelligence life cycle operation.

The MLOps may refer to machine learning operations, and the training unit 400 may configure and train the artificial intelligence life cycle operation for the IoT sensor data through the MLOps.

In detail, the training unit 400 may perform collection, inspection, exploration, integration, preprocessing, and analysis of the data based on the database 200 and the object storage 800 through the MLOps, may perform data feature analysis and appropriate algorithm selection based on the analyzed data, may perform training according to an algorithm, and may perform evaluation and serving of a learning model.

In addition, the training unit 400 may serve a best evaluation model through artificial-intelligence-based service prediction and periodic model evaluation. In other words, an optimal evaluation model may be selected based on artificial intelligence, trained, and retrained by performing model evaluation on new data and comparing a model subjected to the model evaluation with an existing model to derive an optimal and best evaluation model.

The training unit 400 may interwork with the database 200 and the object storage 800 to store a life cycle operation result of the IoT sensor data and the evaluation model and to retrieve and utilize the life cycle operation result of the IoT sensor data and the evaluation model, and a report may be generated based on the life cycle operation result and the evaluation model stored in the database 200 and the object storage 800.

Furthermore, the training unit 400 may function to control the energy-consuming device or the IoT sensor based on the report based on the life cycle operation result and the evaluation model, that is, an artificial intelligence prediction result or anomaly detection for the IoT sensor, so as to perform the real-time monitoring and rapidly handle an emergency situation that may occur in the device and the sensor, and such a function may be performed via an IoT sensor control unit 700 that will be described below.

The distributed energy data platform process according to one aspect of the present disclosure may include an IoT sensor control unit 700 for controlling sensor equipment based on anomaly detection for the IoT sensor installed in the energy-consuming device, an artificial intelligence prediction result, and a user manual.

The IoT sensor control unit 700 may basically configure a protocol component for controlling various types of IoT sensors, and the protocol component may be, for example, based on a known protocol component such as OneM2M, MQTT, AMQP, and gRPC.

In addition, the IoT sensor control unit 700 may include a protocol such as Restful-JWT and OAuth 2.0, which perform security and authentication for each protocol.

In this case, it may be found that the training unit 400 may control the IoT sensor based on the artificial intelligence prediction result or the anomaly detection for the IoT sensor as reviewed above.

In addition, the IoT sensor control unit 700 may provide equipment control based on the user manual.

The expression “based on the user manual” may mean provision of a manual control interface based on the metadata of the IoT sensor in a web GUI environment to the user, in this case, to a user such as a manager of the process according to one aspect of the present disclosure, or a manager in charge of manipulating and maintaining the energy-consuming device or the IoT sensor.

In other words, the IoT sensor control unit 700 may provide rapid handling for the anomaly detection by providing manual control from the user for the IoT sensor based on the user manual, and automatically controlling the IoT sensor based on the artificial intelligence prediction result and the anomaly detection for the IoT sensor.

The IoT sensor control unit 700 may be used to promote result logging, continuous performance evaluation, continuous model improvement, long-term data analysis utilization through feedback and logging based on the IoT sensor data.

According to one aspect of the present disclosure, the server 500 may be intended for the real-time monitoring and anomaly detection alarming based on the IoT sensor data collected from the IoT sensor by the data collection unit 100, and may process real-time streaming data transmission and monitoring data transmission for the IoT sensor data.

In other words, the real-time streaming data described above may be stored in the database 200, and transmitted to the server 500.

As described above, the process according to one aspect of the present disclosure may be named as a main server, in which the server 500 may be a server built inside the process according to one aspect of the present disclosure, but may preferably be built separately outside the process.

In other words, the server 500 according to one aspect of the present disclosure may also be referred to as a web socket server, which may configure data recording and logging separately from the process according to one aspect of the present disclosure, and configure data transmission for each of various clients 600.

It may be preferably understood that the client 600 is a client module for receiving the real-time streaming data and the monitoring data from the server 500 to perform streaming on the real-time streaming data and the monitoring data as shown in FIGS. 3 and 4, rather than a ‘user’.

In other words, the client 600 may configure a dataset in the form of dashboard monitoring for the IoT sensor data collected from the data collection unit 100 so as to serve to provide rapid rendering and alarms to the user or the manager.

In summary, the distributed energy data platform process according to one aspect of the present disclosure may configure an AIoT process based on a distributed energy data platform to collect, verify, preprocess, and predict the IoT sensor data so as to visualize the IoT sensor data to provide the real-time monitoring, which may be retrained to continuously develop the evaluation model, and so as to perform direct and indirect control on the IoT sensor based on the trained and developed evaluation model.

The descriptions of the embodiments set forth herein are provided to enable any person having ordinary skill in the art to use or implement the present disclosure. It will be apparent to a person having ordinary skill in the art that various modifications can be made to the embodiments, and general principles defined herein may be applied to other embodiments without departing from the scope of the present disclosure. Accordingly, the present disclosure is not limited to the embodiments set forth herein, but is to be construed in the broadest scope consistent with the principles and novel features set forth herein.

What is claimed is:

1. A distributed energy data platform process comprising:
a data collection unit for collecting IoT sensor data of an IoT sensor installed in an energy-consuming device in real time;
a database for loading the IoT sensor data collected in real time from the data collection unit;
a visualization unit for interacting with the database so as to visualize the IoT sensor data to monitor the IoT sensor data in real time;
a training unit for configuring an artificial intelligence life cycle operation for the IoT sensor data;
a server for transmitting the IoT sensor data collected in real time from the data collection unit; and
a client for receiving the IoT sensor data transmitted from the server.

2. The distributed energy data platform process of claim 1, wherein the data collection unit includes:
a collection module for streaming-collecting the IoT sensor data in real time;
a verification module for verifying the IoT sensor data in real time;
a preprocessing module for streaming-preprocessing the IoT sensor data in real time; and
a prediction module for streaming-artificial-intelligence-predicting the IoT sensor data in real time.

3. The distributed energy data platform process of claim 1, wherein the database is loaded with at least one data among type-specific real-time streaming data, analysis data, artificial intelligence prediction data, and log data of the IoT sensor data.

4. The distributed energy data platform process of claim 1, wherein the visualization unit includes:
an SQL module for configuring a dataset of the IoT sensor data based on a query;
a widget module for configuring a widget based on the dataset of the IoT sensor data;
a dashboard module for configuring a dashboard based on the dataset and the widget of the IoT sensor data;
a management module for managing the dashboard of the IoT sensor data; and
a rendering module for rendering the IoT sensor data and a state of the energy-consuming device.

5. The distributed energy data platform process of claim 1, wherein the training unit applies machine learning operations (MLOps) to real-time data, and
the artificial intelligence life cycle operation of the training unit includes at least one of data inspection and exploration, preprocessing and feature analysis, algorithm selection, model evaluation, and model serving for the IoT sensor data.

6. The distributed energy data platform process of claim 1, further comprising:
an IoT sensor control unit for controlling sensor equipment based on anomaly detection for the IoT sensor installed in the energy-consuming device, an artificial intelligence prediction result, and a user manual.

7. The distributed energy data platform process of claim 1, further comprising:
an object storage connected to the database so as to perform history backup of the IoT sensor data, training dataset configuration, and column-oriented database backup.
